(19) United States
(12) Patent Application Publication
(10) Pub. No.: US 2010/0064874 A1
(43) Pub. Date: Mar. 18, 2010

(54) Method and device for cooking foodstuffs

(76) Inventor: William L. Nagorka, Edgewater, MD (US)

Correspondence Address: John A. Parrish;Law Offices of John A. Parrish, Suite 300, Two Bala Plaza, Bala Cynwyd, PA, 19004, US

(21) Appl. No.: 12/456,241

(22) Filed: Jun. 12, 2009

Related U.S. Application Data
(60) Provisional application No. 61/131,811, filed on Jun. 12, 2008.

(51) Int. Cl. B26D 3/08

(52) U.S. Cl. 83/883; 83/879

(57) ABSTRACT

The disclosed invention relates a device for lacerating selected portions of link type foodstuffs such as frankfurters, sausage, pepperoni and the like. The device employs a cutter that has a set of cutting elements to form a desired pattern of lacerations on the surface of the foodstuff. The spacing of the cutting elements of the cutter, the depth of those elements, as well as the mass of the cutter may vary over a wide range. Typically, the pattern of cutting elements is configured to form polygonal type spacings between intersecting cutting elements. The pattern of elements, however, may be varied to form a broad range of spacings such as rectangles, pentagons, hexagons, triangles and the like between the elements.

This application claims priority to U.S. Provisional Application 61/131,811 filed Jun. 12, 2008.

### FIELD OF THE INVENTION

The present invention relates to devices and methods for cooking of foodstuffs, especially to devices and methods for cooking of link type foodstuffs such as hot dogs and sausages.

### BACKGROUND OF THE INVENTION

Numerous devices have been proposed for the cutting and/or lacerating of frankfurters. Such devices have used stationary, movable or rotating cutting blades. It is known that a frankfurter can be cooked more quickly if the skin or outer casing is cut or punctured prior to being placed upon a grill or other cooking surface. Various attempts have been made to cut or puncture the skin of a frankfurter but because of its shape, it is difficult to hold on a cutting block while attempting to cut or puncture the skin.

In the field of meat cutlery, cutting tools have been adapted to process a variety of meat products. For example, meat processors often employ cutting tools to slice cylindrical shaped meat products (e.g., hotdog). Additionally, more advanced cutting tools allow for controlled slicing in order to achieve a superficial incision about the surface of the meat product.

It is desirable to provide an apparatus for partially cutting tubular food products, more particularly hot dogs, sausages and similar food products, encased in cellophane or other membrane type holder. Although the deices of the art have been able to score link type foodstuffs such as hot dogs and the like, those devices tend to suffer disadvantages such as inability to uniformly score the food stuff. A continuing need therefore exists for a method and apparatus for scoring of elongated foodstuffs.

### BRIEF DESCRIPTION OF THE DRAWINGS

FIG. 1 is top view of a cutter of the invention;

FIG. 1A is a cross sectional view of cutter of FIG. 1 taken on line A-A.

FIG. 2 shows the attractive appearance achieved in hot dogs after having been lacerated with cutter 1 and cooked.

### SUMMARY OF THE INVENTION

The present invention provides a new and unique device for the cutting and scoring of foodstuffs such as frankfurters. Generally, the invention entails a device for lacerating selected portions of link type foodstuffs such as frankfurters, sausage, pepperoni and the like. The device employs a cutter that has a set of cutting elements to form a desired pattern of lacerations on the surface of the foodstuff. The spacing of the cutting elements of the cutter, the depth of those elements, as well as the mass of the cutter may vary over a wide range. Typically, the pattern of cutting elements is configured to form polygonal type spacings between intersecting cutting elements. The pattern of elements, however, may be varied to form a broad range of spacings such as rectangles, pentagons, hexagons, triangles and the like between the elements.

The device for lacerating elongated cylindrical foodstuffs includes a base 20 having a plurality of first elements 5 and a plurality of second elements 10 that intersect elements 5 wherein elements 5 and elements 10 are attached to base 20 at an attachment angle between the cutting elements and the base 20 of about 66° to about 90°. Elements 5 have a depth that is about equal to the depth of elements 10, and elements 5 have a width that is about equal to the width of elements 10. Elements 5 also have a depth that varies from about 100% to about 125% of the depth of elements 10 and a width that varies from about 100% to about 125% of the width of elements 10. Elements 5 and elements 10 may intersect at an angle a of about 85° to about 90° relative to each other. One or both of elements 5 or elements 10 has a thickness at the base thereof that is about 100% wider than at the cutting edge of the element. Cutter 1 may have a curved base 20 and may be mounted on a curved surface of an elongated cylindrical rolling member.

Having summarized the invention, the invention is described in detail by reference the following detailed description.

### DETAILED DESCRIPTION OF THE INVENTION

Referring to the drawings, cutter 1 includes first cutting elements 5 and second, intersecting cutting elements 10 and base 20. Base 20 may be flat or curved. Cutter 1 may be equipped with a handle to facilitate manual application of pressure to cutter 1 during the laceration of foodstuffs such as hot dogs.

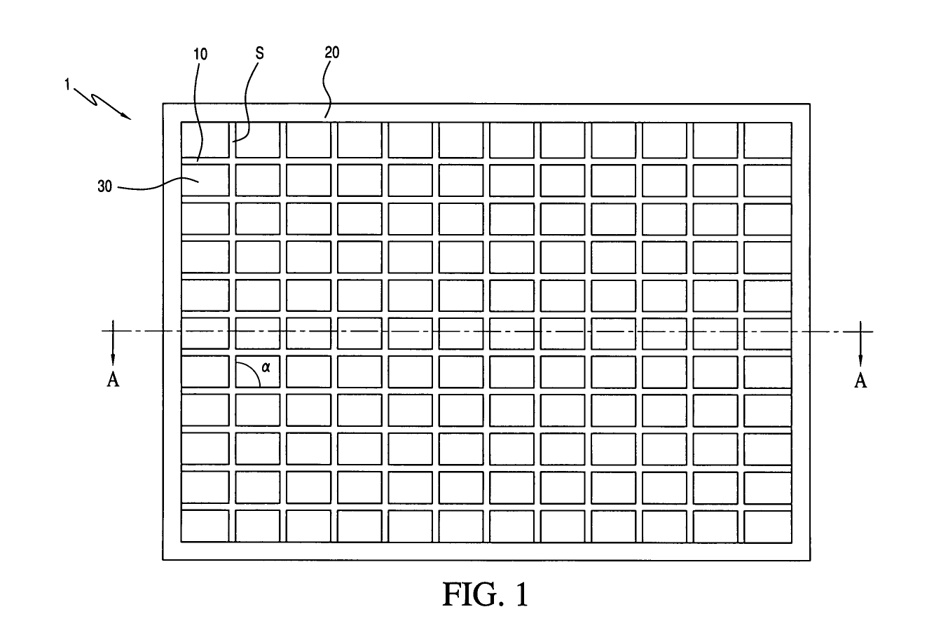

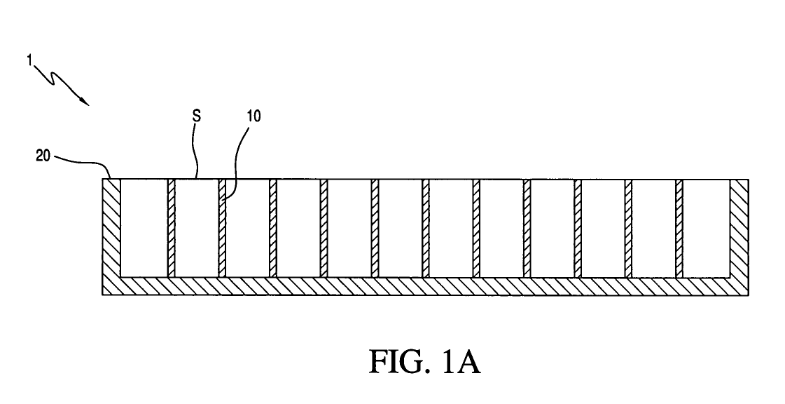

Cutter 1 such as shown in FIG. 1 may be formed by methods such as machining of elements 5 and 10 from a metal block such as brass, stainless steel, carbides such as TiC, metal alloys such as Endurium and the like. Cutter 1 having elements 5 and 10 also may be made by casting as well as by assembling a set of intersecting blades in a frame. Preferably, elements 5 and 10 project from base 20 at an angle of about 90° to base 20 to about 85° to base 20, preferably about 85° to about 90° relative to base 20.

As shown in FIG. 1, elements 5 and 10 intersect to form spacings 30 between elements 5 and 10. Spacings 30 may be have a wide variety of configurations such as polygons such as squares, rectangles, pentagons, hexagon and the like, as well as shapes such as circles, ovals and the like. Preferably, spacings 30 are in the form of polygons such as squares or rectangles. Adjacent spacings 30 may be the same or different.

The pattern of intersecting elements on the cutter grid may vary to generate a wide variety of laceration patterns on the foodstuff. These patterns may be in the form of grids, spirals, cylindrical lacerations that encircle the circumference of the foodstuff, straight lines along the length of the foodstuff, and the like. The depth of lacerations may vary with the type of foodstuff that is being lacerated. The lacerations may be uniformly or non-uniformly distributed over the surface area of the foodstuff. Preferably, the lacerations are uniformly distributed.

When elements 5 and intersecting elements 10 intersect to form square shaped spacings as shown in FIG. 1, the size of the spacings may vary. Typically, square spacings have a size of about 0.166 inches to about 0.25 inches on a side, preferably about 0.125 inches on a side.

Elements 5 and elements 10 may intersect at any desired angle a relative to each other. Typical angles of intersection of elements 5 and elements 10 may vary from about 90° to about 120° relative to each other. The depths and widths of each of elements 5 and 10 may vary over a wide range relative to each other. The depth and width of elements 5 may be the same or different as the depth and width of elements 10.

Elements 5 typically have about the same depth as elements 10, and elements 5 also may have about the same width as elements 10. Typically, elements 5 have a depth of about 0.125 inches to about 0.25 inches, preferably about 0.166 inches to about 0.25 inches, more preferably about 0.125 inches. Intersecting elements 10 typically have a depth of about 0.125 inches to about 0.25 inches, preferably about 0.166 inches to about 0.25 inches, more preferably about 0.125 inches.

Elements 5 may have a depth that varies from about 100% to about 125% of the depth of elements 10, preferably about 100% to about 110% of the depth of elements 10, most preferably about 100% of the depth of elements 10.

Elements 5 may have a width that varies from about 100% to about 125% of the width of elements 10, preferably about 100% to about 110% of the width of elements 10, most preferably about 100% of the width of elements 10.

Elements 5 and 10 may vary in width from the cutting surface of the elements to the base of the elements on base 20. Typically, the elements may have a width at the based portion that is up to about 66% of the width of the cutting surface of the elements.

Cutter 1 may be impressed onto the foodstuff in a wide variety of ways. Cutter 1 may be manually impressed onto the foodstuff. Cutter 1 may also be mounted on the surface of a curved member such as a cylindrical roller for impression onto a foodstuff such as a hotdog such as where the hotdog is on an endless belt and the hotdog passes underneath the roller surface. Alternatively, the hotdogs may be passed through opposing rollers that bear cutter 1. In one aspect, cutter 1 such as shown for example in FIG. 1 may be employed in a machine such as that shown in U.S. Pat. No. 2,615,196, the teachings of which are incorporated by reference by their entirety herein.

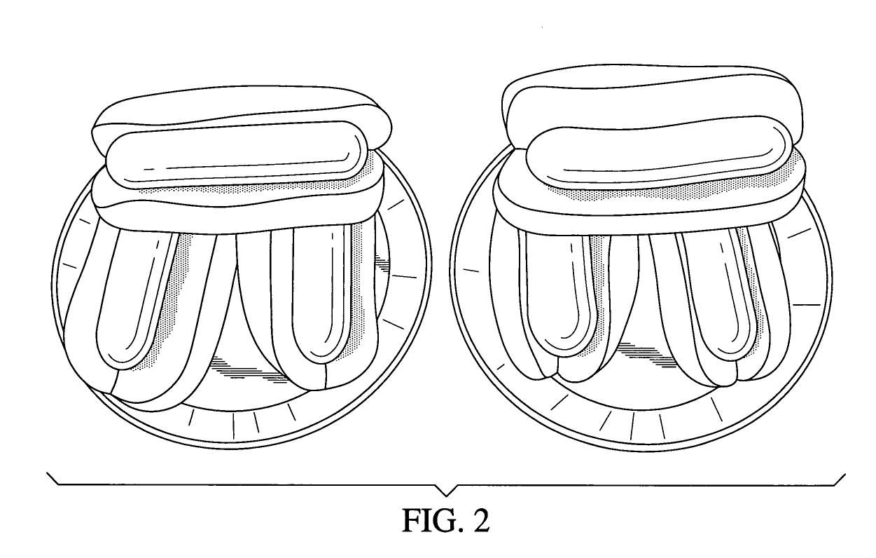

Lacerating of a link type foodstuff such as a hot dog with cutter 1 enables the foodstuff to be cooked by methods such as deep frying, pan frying, microwaving, broiling and boiling very quickly and with enhanced taste. The lacerations provided by cutter 1 enable the foodstuff, after cooking, to have a set of striations that correspond from the lacerations formed in the foodstuff by the cutting device. The cooked foodstuff such as a hotdog, moreover, has an attractive appearance such as is shown in FIG. 2.

In use, cutter 1 is compressed onto a foodstuff such as a link type foodstuff such as a sausage or a hot dog to lacerate all or a portion of the foodstuff to a desired depth. Foodstuffs especially suitable for treatment with cutter 1 have a ratio of length to diameter of about 5.75 to about 1. Typically, a link type foodstuff such as a hot dog is pierced to a depth of about 0.125 to about 0.25 inches, preferably about 0.166 to about 0.25 inches, more preferably about 0.166 to about 0.25 inches.

Where link sausages are lacerated, the depth of lacerations may vary from about 3 mm to about 5 mm, preferably about 4 millimeter to about 5 millimeter. The lacerations may cover about 80 percent to about 90% of the surface area of the foodstuff, preferably about 85% to about 90% of the surface area of the sausage. Sausages that are lacerated in this way may be cooked by microwave in about 170 seconds to about 185 seconds, by boiling water in about 480 seconds to about 600 seconds, by oil at about 350 degrees Fahrenheit to about 375 degrees Fahrenheit in about 55 seconds to about 65 seconds, and by grilling in about 150 seconds to about 170 seconds. When the foodstuff is a hotdog, the area of coverage of lacerations may cover upto about 80% to upto about 90% of the surface area of the hotdog, preferably about 80% to about 90%, more preferably about 85% to about 90%. The depth of the lacerations may vary from about 3 mm to about 5 mm, preferably about 4 millimeter to about 5 millimeter. Hot dogs that have lacerations of about this extent of coverage and of about these depths may be cooked by microwave in about 40 seconds to about 60 seconds, by boiling water in about 60 seconds to about 70 seconds, by oil at a temperature of about 355 degrees Fahrenheit to about 370 degrees Fahrenheit in about 55 seconds to about 80 seconds and by grilling in about 150 seconds to about 170 seconds. Link type foodstuffs such as hot dogs which have been lacerated to a depth of about 0.125 inches to about 0.166 inches may be deep fried in oils such as vegetable oil, peanut oil and canola oil, preferably peanut oil over a temperature range of about 350 F to about 375 F, preferably about 360 F to about 375 F, for a time period of about 60 sec to about 75 sec, preferably about 70 sec.

Link type foodstuffs such as hot dogs which have been lacerated to a depth of about 0.166 inches to about 0.25 inches may be pan fried in oils such as vegetable oil, peanut oil and canola oil, preferably peanut oil over a temperature range of about 350 F to about 375 F, preferably about 360 F to about 375 F for a time period of about 75 sec to about 120 sec, preferably about 120 sec.

Link type foodstuffs such as hot dogs which have been lacerated to a depth of about 0.125 inches to about 0.25 inches may be broiled for a time period of about 180 sec to about 195 sec under constant rotation, preferably about 195 sec.

Link type foodstuffs such as hot dogs which have been lacerated to a depth of about 0.125 inches to about 0.25 inches may be boiled in water for a time period of about 240 sec to about 270 sec, preferably about 270 sec.

1. A device for lacerating elongated cylindrical foodstuffs comprising,
the base member having a plurality of first elements 5 and a plurality of second elements 10 that intersect elements 5,
wherein elements 5 and elements 10 are attached to base 20 at an attachment angle between the cutting elements and the base 20 of about 66° to about 90°.

2. The device of claim 1 wherein elements 5 have a depth that is about equal to the depth of elements 10, and elements 5 a width that is about equal to the width of elements 10.

3. The device of claim 2, wherein elements 5 have a depth that varies from about 100% to about 125% of the depth of elements 10.

4. The device of claim 1 wherein elements 5 have a width that varies from about 100% to about 125% of the width of elements 10.

5. The device of claim 1 wherein elements 5 and elements 10 intersect at an angle α of about 85° to about 90° relative to each other.

6. The device of claim 1 wherein one or both of elements 5 or elements 10 has a thickness at the base thereof that is about 100% wider than at the cutting edge of the element.

7. The device of claim 1 wherein the cutter 1 has a curved base 20 and is mounted on a curved surface of an elongated cylindrical rolling member.

8. The device of claim 1 wherein elements 5 elements 10 intersect to form square shaped spacings between elements 5 and 10.

9. The device of claim 1 wherein elements 5 and 10 intersect to form rectangular spacings between elements 5 and 10.

10. The device of claim 1 wherein elements 5 and 10 intersect to form circular type spacings.
